(19) United States
(12) Patent Application Publication
(10) Pub. No.: US 2015/0074127 A1
(43) Pub. Date: Mar. 12, 2015

(54) Creating Visualizations from Data in Electronic Documents

(71) Applicant: Microsoft Corporation, Redmond, WA (US)

(72) Inventors: Jennifer Marie Cherwinka, Seattle, WA (US); Neha Chandrashekhar Waikar, Seattle, WA (US); Kerry Young, Redmond, WA (US); Julianne M. Bryant, Seattle, WA (US); Jeffrey S. Berg, Seattle, WA (US); Jeffrey Jon Weir, Seattle, WA (US)

(73) Assignee: Microsoft Corporation, Redmond, WA (US)

(21) Appl. No.: 14/022,656

(22) Filed: Sep. 10, 2013

(51) Int. Cl. G06F 17/30

(52) U.S. Cl. CPC G06F 17/30994
USPC 707/755

(57) ABSTRACT

Creating visualizations from human readable data in electronic documents is provided. One or more facts may be parsed from an electronic document by a computing device. The one or more facts may consist of a human readable sentence. A search may then be performed for an icon based on the one or more facts. The computing device may then generate a data visualization, such as an infographic, which includes the one or more facts and the icon. The generated data visualization may then be displayed in the electronic document.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Productivity software applications are often utilized for generating graphics (e.g., “infographics”) from user-provided data. Currently however, the process of creating graphics that represent user-provided data is a labor and time intensive task requiring, among other things, performing data analytics operations for running through large information or data sets in order to identify a single statement for representing as a data visualization (e.g., an infographic composed of icons, charts, typography and factoids). It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for creating visualizations from data in electronic documents. One or more facts may be parsed from an electronic document by a computing device. The one or more facts may consist of a human readable sentence. A search may then be performed for a graphic (e.g., an icon) based on the one or more facts. The computing device may then generate a data visualization including the one or more facts and the graphic (e.g., an infographic). The generated data visualization may then be displayed in the electronic document.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for creating visualizations from data in electronic documents, in accordance with various embodiments;

FIG. 2 is a diagram showing a created visualization from data in an electronic document, in accordance with an embodiment;

FIG. 3 is a user interface which may be utilized for creating visualizations from data in electronic documents, in accordance with an embodiment;

FIG. 4A is a user interface which may be utilized for creating visualizations from data in electronic documents, in accordance with an embodiment;

FIG. 4B is a user interface which may be utilized for creating visualizations from data in electronic documents, in accordance with an embodiment;

FIG. 5 is a user interface which may be utilized for creating visualizations from data in electronic documents, in accordance with an embodiment;

FIG. 6 is a user interface which may be utilized for creating visualizations from data in electronic documents, in accordance with an embodiment;

FIG. 7 is a user interface which may be utilized for creating visualizations from data in electronic documents, in accordance with an embodiment;

FIG. 8 is a user interface which may be utilized for creating visualizations from data in electronic documents, in accordance with an embodiment;

FIG. 9 is a flow diagram illustrating a routine for creating visualizations from data in electronic documents, in accordance with an embodiment;

FIG. 10 is a simplified block diagram of a computing device with which various embodiments may be practiced;

FIG. 11A is a simplified block diagram of a mobile computing device with which various embodiments may be practiced;

FIG. 11B is a simplified block diagram of a mobile computing device with which various embodiments may be practiced; and

FIG. 12 is a simplified block diagram of a distributed computing system in which various embodiments may be practiced.

### DETAILED DESCRIPTION

Embodiments are provided for creating visualizations from data in electronic documents. One or more facts may be parsed from an electronic document by a computing device. The one or more facts may consist of a human readable sentence. A search may then be performed for a graphic (e.g., an icon) based on the one or more facts. The computing device may then generate a data visualization including the one or more facts and the graphic (e.g., an infographic). The generated data visualization may then be displayed in the electronic document.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

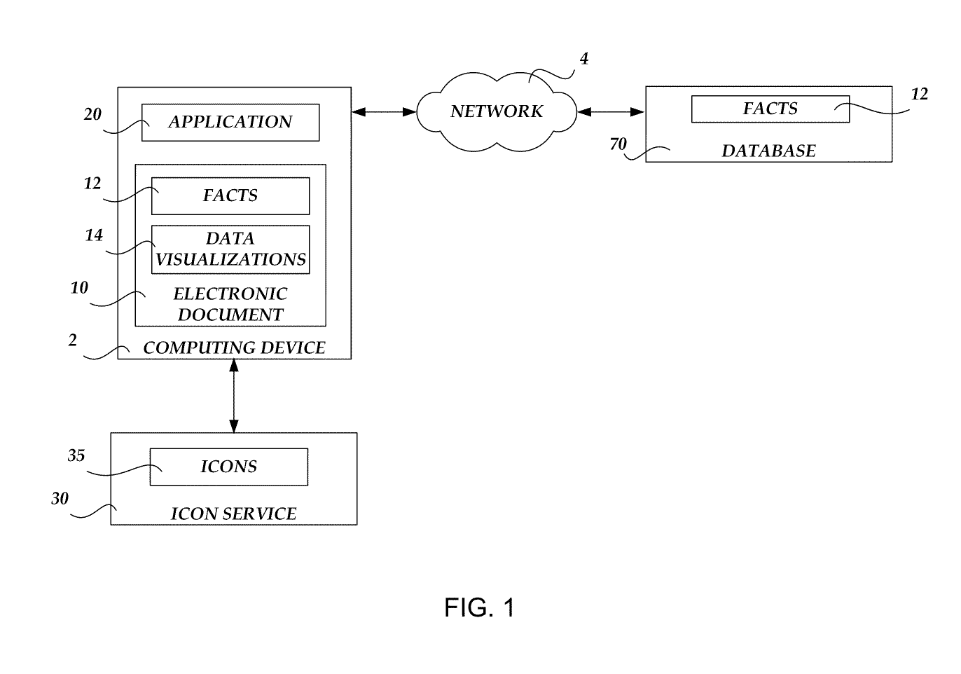

FIG. 1 is a block diagram illustrating a network architecture for creating visualizations from data in electronic documents, in accordance with various embodiments. The network architecture includes a computing device 2 which is in communication with a database 70 over a network 4 which may include a local network or a wide area network (e.g., the Internet). In accordance with an embodiment, the computing device 10 may comprise a desktop or mobile computing device (e.g., a tablet, laptop computing device or smartphone) which is utilized executing one or more application programs such as the application 20. The computing device 2 may further comprise one or more electronic documents 10. As will be described in greater detail herein, the application 20 may be configured to generate data visualizations 14 from electronic document data (e.g., facts 12). It should be understood that the facts 12 may include human readable sentences. The computing device 2 may also be in communication with icon service 30 which stores icons 35. As will be described in greater detail herein, the application 20 may search for and retrieve the facts 12 and one or more of the icons 35 corresponding to the facts 12, and further generate data visualizations (e.g., infographics) from the search results. In accordance with some embodiments, the application 20 may comprise productivity application software which may include, but is not limited to, word processing software, presentation graphics software, spreadsheet software and diagramming software. For example, the application 20 may comprise one or more of the following software applications: the WORD word processing software, POWERPOINT presentation graphics software, EXCEL spreadsheet software and VISIO diagramming software from MICROSOFT CORPORATION of Redmond, Wash. It should be appreciated that the aforementioned software applications may comprise individual application programs or alternatively, may be incorporated into a suite of applications such as the OFFICE application program suite from MICROSOFT CORPORATION. In accordance with other embodiments, the application 20 may alternatively comprise a service, such as a web service engine. In these embodiments, the service may be utilized to search for and retrieve the facts 12 and one or more of the icons 35 corresponding to the facts 12, and further generate a data visualization (e.g., an infographic, chart or factoid) from the search results. It should be appreciated that, in accordance with some embodiments, the generated data visualization may also comprise other types of graphics such as SMARTART graphics which are provided by MICROSOFT CORPORATION of Redmond, Wash. An illustrative service which may be utilized in accordance with these embodiments may include the BING web search engine provided by MICROSOFT CORPORATION of Redmond, Wash. It should be understood that the embodiments described herein may also be practiced in conjunction with other application programs and web services and further, are not limited to any particular application service.

In accordance with an embodiment, the icons 35 may comprise a preset group of editable and formatted diagrams. The icons 35 may also be configured to map and automatically resize added text for a best fit. It should be understood, that in accordance with an embodiment, the data visualizations 14 may comprise information graphics (or “infographics”) which may include, without limitation, graphic visual representations of information, data and knowledge for the presentation of information. In particular, the data visualizations 14 described herein, may comprise a combination of the facts 12 and the icons (or graphics) 35.

The database 70 may comprise an information repository (such as an encyclopedia) from which the application 20 executing on the computing device 2 may retrieve the facts 12 for use in generating data visualizations. In accordance with an embodiment, the database 70 may comprise an online encyclopedia or other data source or reference which provides a summary of information from one or more branches of knowledge.

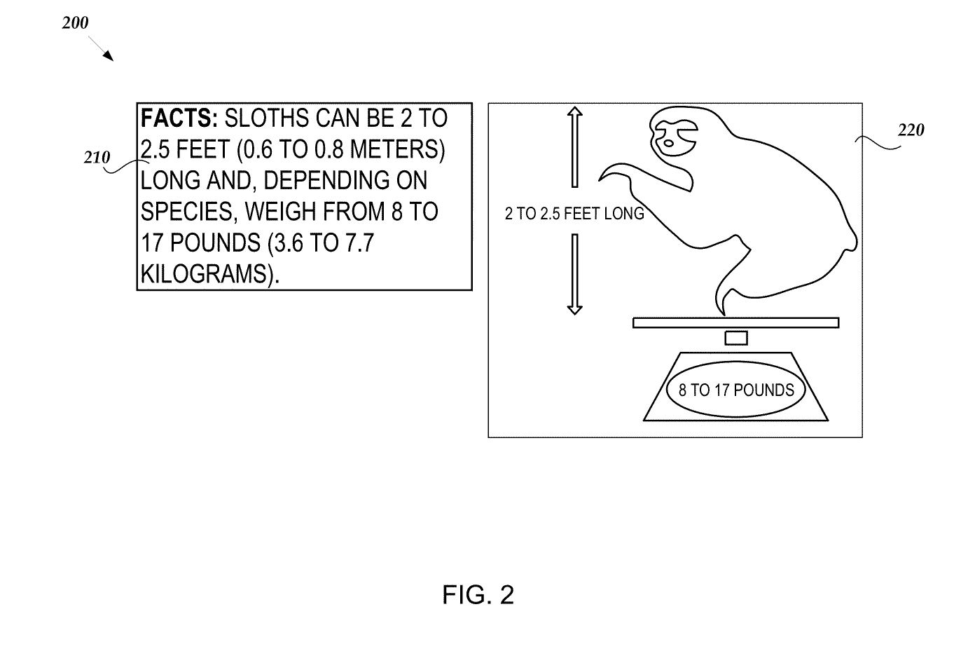

FIG. 2 is a diagram 200 showing a created visualization from data in an electronic document, in accordance an embodiment. The diagram 200 includes a set of facts 210 (i.e., human readable data) and an infographic 220 created therefrom. In particular, and as will be described in greater detail below, the infographic 220 may be generated from the facts 210 by the application 20 parsing the facts 210 and searching for a graphic or icon corresponding to the parsed facts. For example, as shown in FIG. 2, the facts 210 describe the length and weight of sloths. Accordingly, the application 20 may retrieve (e.g., from the icon service 30) a graphic corresponding to a sloth and insert corresponding facts (i.e., parsed from the facts 210) associated with length and weight, respectively. It should be understood that the aforementioned length and weight measures may alternatively be retrieved from graphics which already contain abstract concept of length and weight, respectively.

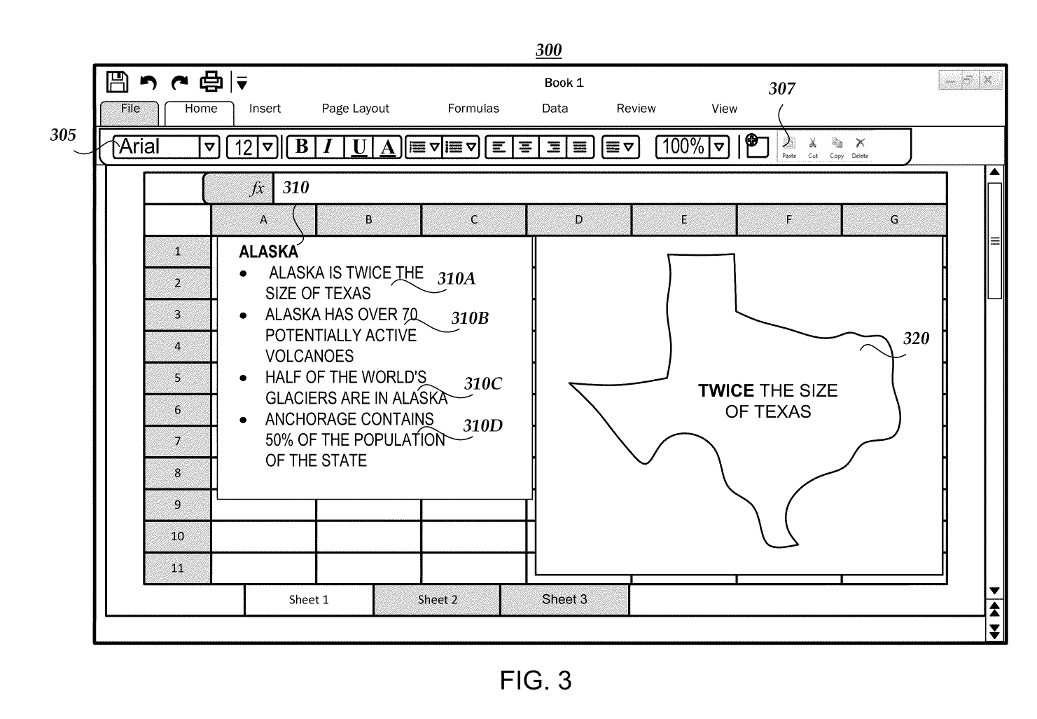

FIG. 3 is a user interface 300 which may be utilized for creating visualizations from data in electronic documents, in accordance an embodiment. The user interface 300 includes a ribbon 305 corresponding to a spreadsheet which may be generated by the application 20. It should be understood that the user interface 300 is illustrative only and that some of the above-described components, such as the ribbon 305 may be optional in accordance with various embodiments. The user interface 300 further includes a set of facts 310 (i.e., human readable data comprising facts 310A, 310B, 310C and 310D) associated with the state of Alaska. In some embodiments, the set of facts 310 may be copied from a data repository (e.g., an online encyclopedia) and inserted (e.g., using Paste user control 307) into the spreadsheet in the user interface 300. The user interface 300 further includes an infographic 320 which may be generated by the application 20 from the fact 310A comparing the size of the state of Alaska with respect to the state of Texas. In particular, the infographic 320 may be generated from the fact 310A by parsing the fact 310A and searching for a graphic or icon corresponding to the parsed fact.

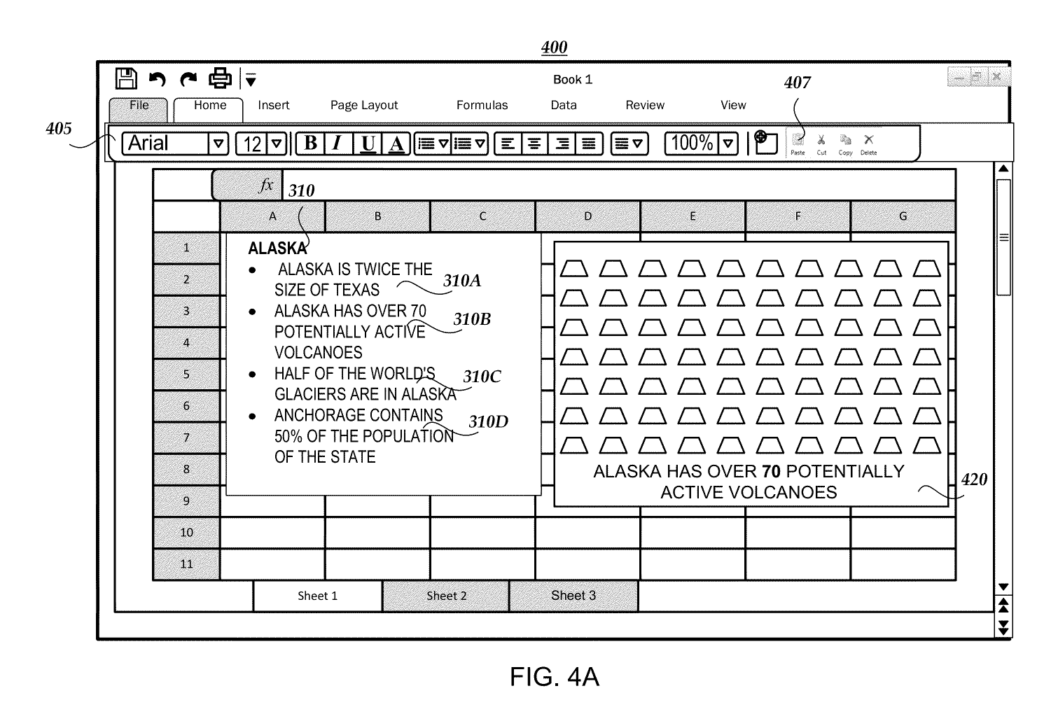

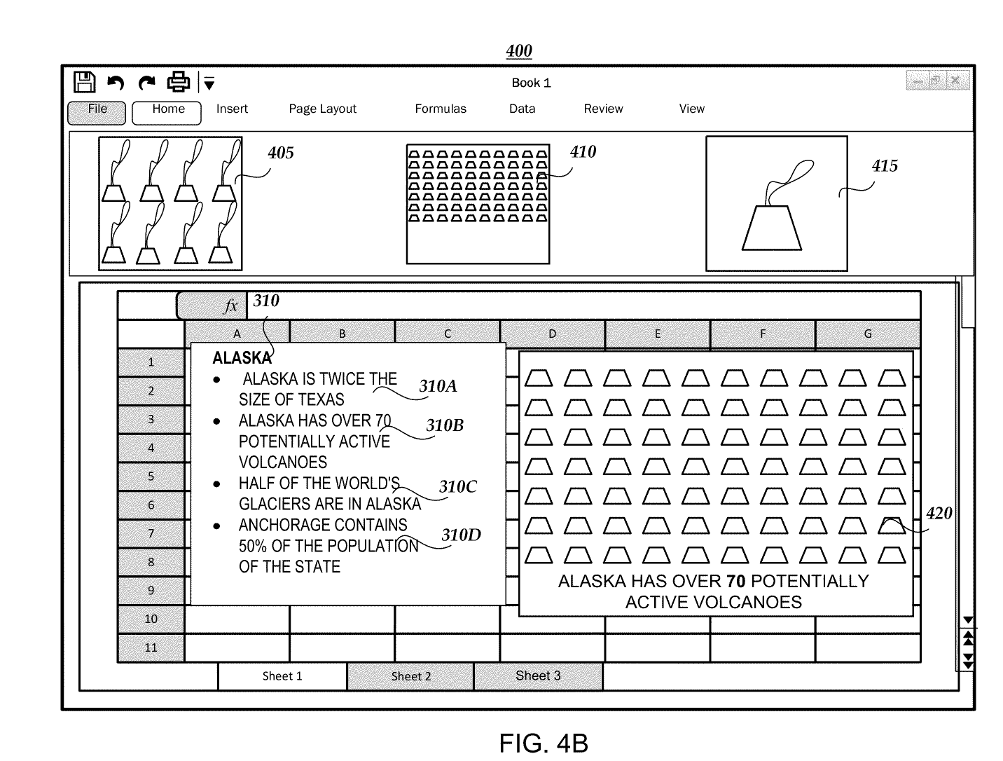

FIG. 4A is a user interface 400 which may be utilized for creating visualizations from data in electronic documents, in accordance an embodiment. The user interface 400 includes a ribbon 405 corresponding to a spreadsheet which may be generated by the application 20. As discussed above with respect to FIG. 3, the ribbon 405 in the user interface 400 may be optional in accordance with some embodiments. The user interface 400 further includes the set of facts 310 (comprising facts 310A, 310B, 310C and 310D) associated with the state of Alaska. In some embodiments, the set of facts 310 may be copied from a data repository (e.g., an online encyclopedia) and inserted (e.g., using Paste user control 407) into the spreadsheet in the user interface 400. The user interface 400 further includes an infographic 420 which may be generated by the application 20 from the fact 310B describing the number of potentially active volcanoes in the state of Alaska. In particular, the infographic 420 may be generated by from the fact 310A by parsing the fact 310A and searching for graphics or icons corresponding to the parsed fact.

FIG. 4B shows the user interface 400 (without the optional ribbon 405) which may be utilized for creating visualizations from data in electronic documents, in accordance another embodiment. The user interface 400 includes a display of icons 405, 410 and 415 for use in generating a data visualization (i.e., the infographic 420) which is based on the fact 310B in the set of facts 310.

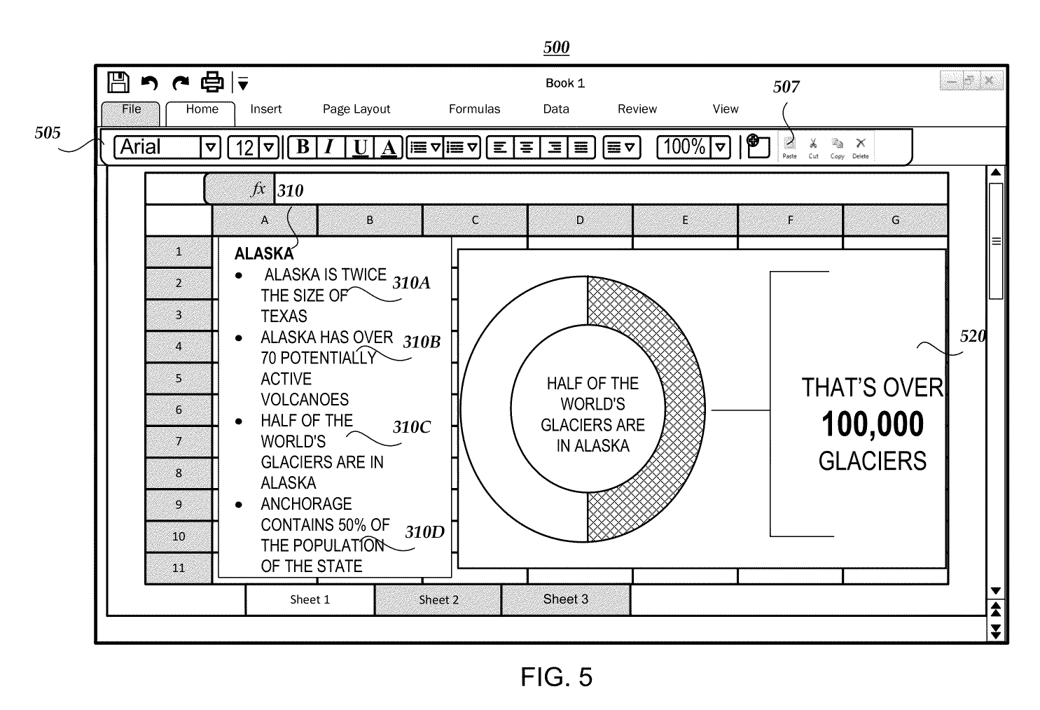

FIG. 5 is a user interface 500 which may be utilized for creating visualizations from data in electronic documents, in accordance an embodiment. The user interface 500 includes a ribbon 505 corresponding to a spreadsheet which may be generated by the application 20. As discussed above with respect to FIGS. 3 and 4, the ribbon 505 in the user interface 500 may be optional in accordance with some embodiments. The user interface 500 further includes the set of facts 310 (comprising facts 310A, 310B, 310C and 310D) associated with the state of Alaska. In some embodiments, the set of facts 310 may be copied from a data repository (e.g., an online encyclopedia) and inserted (e.g., using Paste user control 507) into the spreadsheet in the user interface 500. The user interface 500 further includes an infographic 520 which may be generated by the application 20 from the fact 310C describing the number of glaciers in the state of Alaska. In particular, the infographic 520 may be generated by from the fact 310C by parsing the fact 310C and searching for graphics or icons corresponding to the parsed fact. It should be understood that in accordance with some embodiments, the generation of the chart shown in the infographic 520 may be preceded by the generation of a temporary data set by a spreadsheet application program utilized to generate the infographic 520.

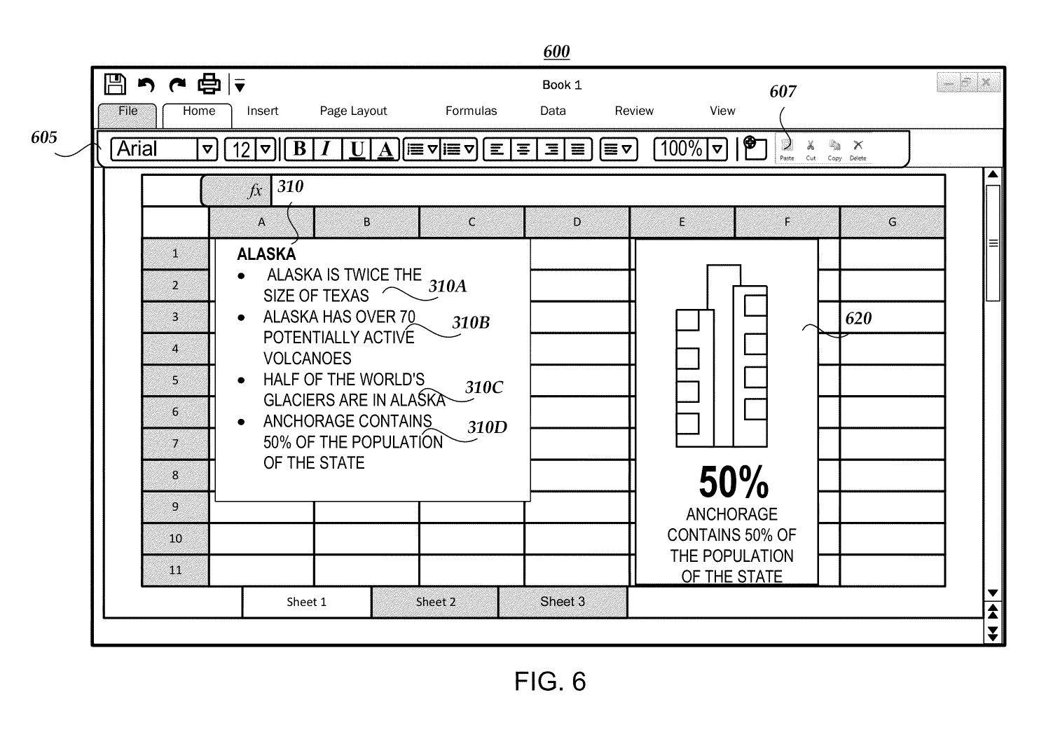

FIG. 6 is a user interface 600 which may be utilized for creating visualizations from data in electronic documents, in accordance an embodiment. The user interface 600 includes a ribbon 605 corresponding to a spreadsheet which may be generated by the application 20. As discussed above with respect to FIGS. 3-5, the ribbon 605 in the user interface 600 may be optional in accordance with some embodiments. The user interface 600 further includes the set of facts 310 (comprising facts 310A, 310B, 310C and 310D) associated with the state of Alaska. In some embodiments, the set of facts 310 may be copied from a data repository (e.g., an online encyclopedia) and inserted (e.g., using Paste user control 607) into the spreadsheet in the user interface 600. The user interface 600 further includes an infographic 620 which may be generated by the application 20 from the fact 310D describing the percentage of the population in the state of Alaska residing in the city of Anchorage. In particular, the infographic 620 may be generated by from the fact 310D by parsing the fact 310D and searching for graphics or icons corresponding to an associated abstract concept (i.e., a metropolis icon for representing the population of a municipality).

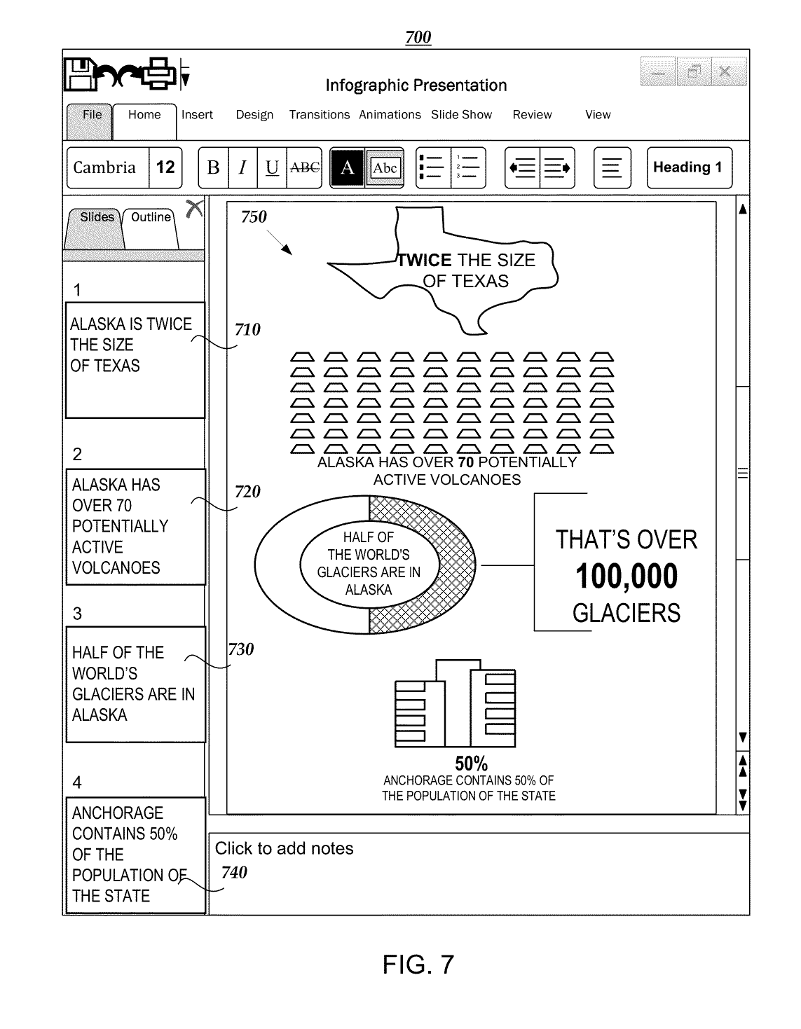

FIG. 7 is a user interface 700 which may be utilized for creating visualizations from data in electronic documents, in accordance an embodiment. The user interface 700 shows presentation slides 710, 720, 730 and 740, each of which corresponds to the set of facts 310 (comprising facts 310A, 310B, 310C and 310D) associated with the state of Alaska. The user interface 700 also includes a composition 750 of infographics created from the aforementioned facts. In particular, and in accordance with an embodiment, a slideshow comprising a set of facts may be converted into an infographic compilation by parsing an entire electronic document for a set of facts, creating graphics for each fact and then merging the facts into a composition (e.g., the composition 750). Thus, it should be appreciated that the composition 750 may act as a “summary” graphic for an entire slide presentation.

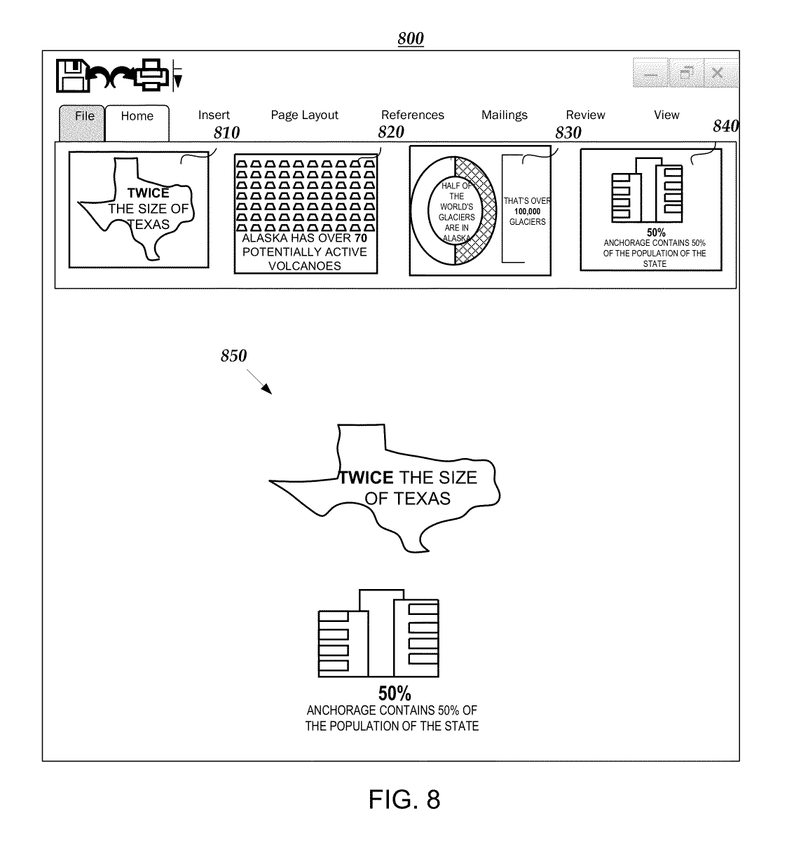

FIG. 8 is a user interface 800 which may be utilized for creating visualizations from data in electronic documents, in accordance an embodiment. The user interface 800 shows a gallery comprising infographics 810, 820, 830 and 840 as well as a composition 850 created from infographics 810 and 840. In accordance with an embodiment, infographics generated for a collection of facts may be selected from a gallery for merging into a composition.

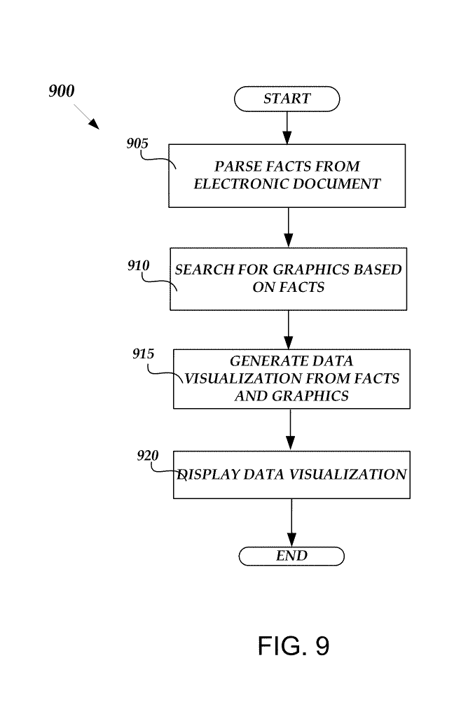

FIG. 9 is a flow diagram illustrating a routine 900 for creating visualizations from data in electronic documents, in accordance an embodiment. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 9 and making up the various embodiments described herein are referred to variously as operations, structural devices, acts or modules. It will be recognized by one skilled in the art that these operations, structural devices, acts and modules may be implemented in software, in hardware, in firmware, in special purpose digital logic, and any combination thereof without deviating from the spirit and scope of the present invention as recited within the claims set forth herein.

The routine 900 begins at operation 905, where the application 20 executing on the computing device 10, may parse one or more of the facts 12 from an electronic document (i.e., the electronic document 10). In particular, the application 20 may utilize natural language processing to parse the facts 12 retrieved into the electronic document from the database 70 into a human readable form. It should be appreciated that the facts 12 may be retrieved utilizing a number of methods. For example, the facts 12 may be retrieved by copying facts (i.e., from one or more documents) from the database 70 and inserting the facts into the electronic document 10. In some embodiments, the application 20 may utilize a natural language processor to retrieve the facts 12 from a user's speech. Alternatively, the application 20 may be configured to provide a template for the user to type in information (e.g., sentences, factoids, etc.) according to a specific format so that the information may be parsed quickly by the application 20.

From operation 905, the routine 900 continues to operation 910, where the application 20 executing on the computing device 10, may search for a graphic or icon based on the facts 12 parsed at operation 905. For example, the application 20 may search the icon service 30 to retrieve one or more of the icons 35 which correspond to the facts 12.

From operation 910, the routine 900 continues to operation 915, where the application 20 executing on the computing device 10, may generate a data visualization (e.g., an infographic) which includes the facts 12 and the graphic or icon retrieved at operation 910. In accordance with an embodiment, the application 20 may be configured to automatically generate one or more temporary data sets in generating the data visualization. It should also be appreciated that the application 20 may generate the data visualization utilizing a number of methods. For example, in accordance with some embodiments, the application 20 may be configured to automatically (i.e., utilizing an algorithm) determine a graphic or icon from a set of options which best corresponds with the facts 12. An algorithm which may utilized for performing the aforementioned determination is described in related patent application U.S. Ser. No. 13/272,522 entitled “Suggesting Alternate Data Mappings for Charts,” filed on Oct. 13, 2011, the disclosure of which is incorporated herein, in its entirety, by reference. In accordance with other embodiments, the application 20 may be configured to present a plurality of graphic or icon options to a user who may then select a preferred graphic or icon for use in generating a data visualization based on the facts 12.

From operation 915, the routine 900 continues to operation 920, where the application 20 executing on the computing device 10, may display the data visualization generated at operation 915. In accordance with some embodiments, the data visualization may be displayed inline in an electronic document (such as a spreadsheet). In accordance with other embodiments, the data visualization may be displayed in a gallery. From operation 920, the routine 900 then ends.

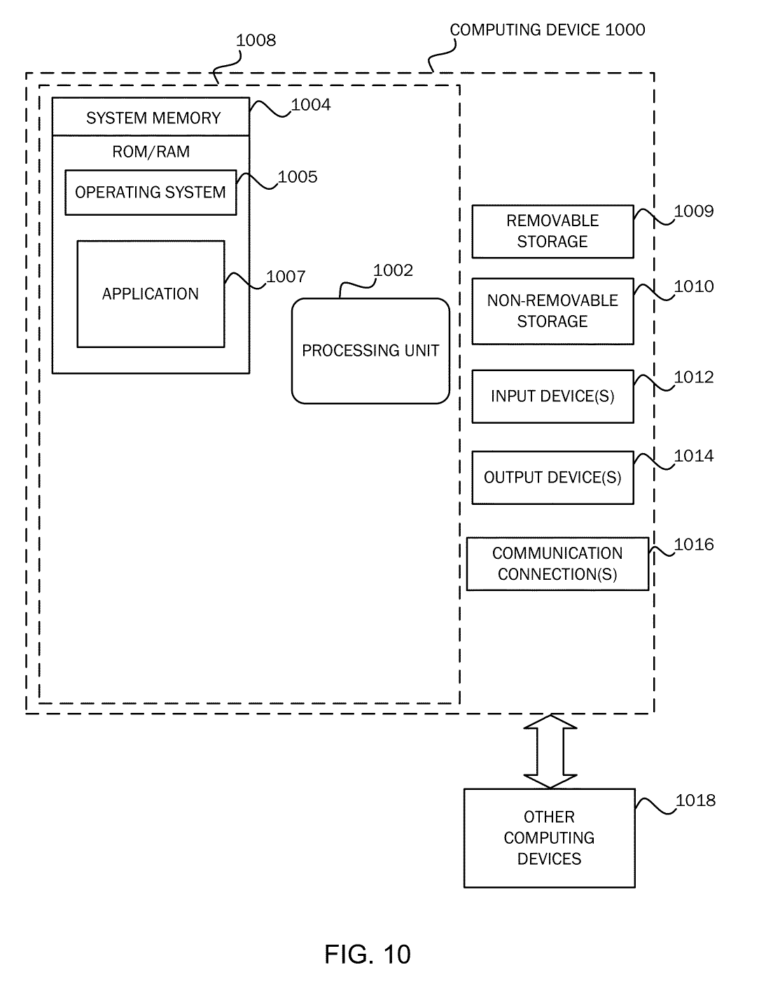

FIGS. 10-12 and the associated descriptions provide a discussion of a variety of operating environments in which embodiments of the invention may be practiced. However, the devices and systems illustrated and discussed with respect to FIGS. 10-12 are for purposes of example and illustration and are not limiting of a vast number of computing device configurations that may be utilized for practicing embodiments of the invention, described herein.

FIG. 10 is a block diagram illustrating example physical components of a computing device 1000 with which various embodiments may be practiced. In a basic configuration, the computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include an operating system 1005 and application 1007. Operating system 1005, for example, may be suitable for controlling the computing device 1000's operation and, in accordance with an embodiment, may comprise the WINDOWS operating systems from MICROSOFT CORPORATION of Redmond, Wash. The application 1007, for example, may comprise functionality for performing routines including, for example, creating visualizations from data in electronic documents, as described above with respect to the operations in routine 900 of FIG. 9. In accordance with an embodiment, the application 1007 may comprise a productivity software application (or alternatively, a productivity software application suite) for creating, viewing and editing charts such as the EXCEL spreadsheet application program from MICROSOFT CORPORATION of Redmond, Wash. It should be understood however, that the application 1007 may also comprise other types of productivity software applications including, but not limited to, word processing applications, presentation applications and note-taking/collaboration applications. It should further be understood, however, that the embodiments described herein may also be practiced in conjunction with other application programs and further, is not limited to any particular application or system.

The computing device 1000 may have additional features or functionality. For example, the computing device 1000 may also include additional data storage devices (removable and/or non-removable) such as, for example, magnetic disks, optical disks, solid state storage devices (“SSD”), flash memory or tape. Such additional storage is illustrated in FIG. 10 by a removable storage 1009 and a non-removable storage 1010. The computing device 1000 may also have input device(s) 1012 such as a keyboard, a mouse, a pen, a sound input device (e.g., a microphone), a touch input device for receiving gestures, an accelerometer or rotational sensor, etc. Output device(s) 1014 such as a display, speakers, a printer, etc. may also be included. The aforementioned devices are examples and others may be used. The computing device 1000 may include one or more communication connections 1016 allowing communications with other computing devices 1018. Examples of suitable communication connections 1016 include, but are not limited to, RF transmitter, receiver, and/or transceiver circuitry; universal serial bus (USB), parallel, and/or serial ports.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 1000 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

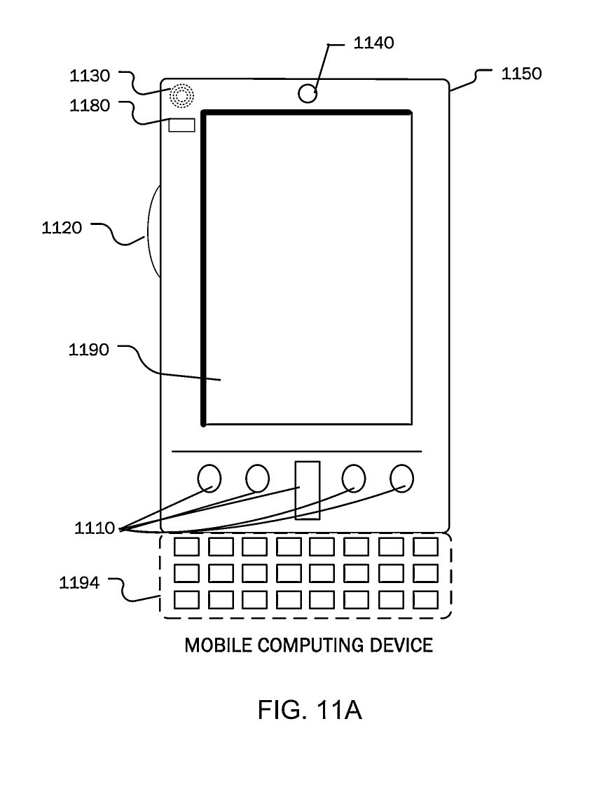

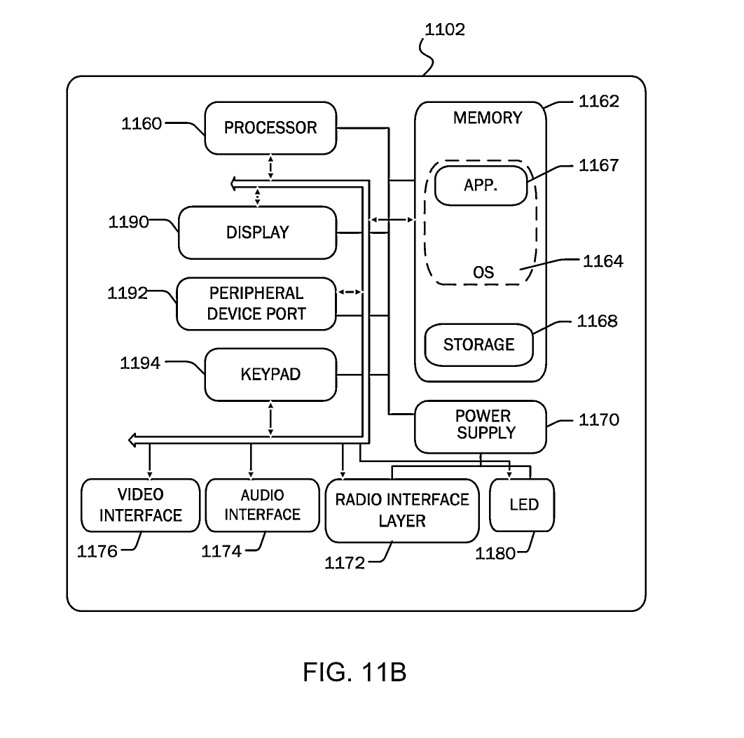

FIGS. 11A and 11B illustrate a suitable mobile computing environment, for example, a mobile computing device 1150 which may include, without limitation, a smartphone, a tablet personal computer, a laptop computer, and the like, with which various embodiments may be practiced. With reference to FIG. 11A, an example mobile computing device 1150 for implementing the embodiments is illustrated. In a basic configuration, mobile computing device 1150 is a handheld computer having both input elements and output elements. Input elements may include touch screen display 1125 and input buttons 1110 that allow the user to enter information into mobile computing device 1150. Mobile computing device 1150 may also incorporate an optional side input element 1120 allowing further user input. Optional side input element 1120 may be a rotary switch, a button, or any other type of manual input element. In alternative embodiments, mobile computing device 1150 may incorporate more or less input elements. In yet another alternative embodiment, the mobile computing device is a portable telephone system, such as a cellular phone having display 1125 and input buttons 1110. Mobile computing device 1150 may also include an optional keypad 1105. Optional keypad 1105 may be a physical keypad or a “soft” keypad generated on the touch screen display.

Mobile computing device 1150 incorporates output elements, such as display 1125, which can display a graphical user interface (GUI). Other output elements include speaker 1130 and LED 1180. Additionally, mobile computing device 1150 may incorporate a vibration module (not shown), which causes mobile computing device 1150 to vibrate to notify the user of an event. In yet another embodiment, mobile computing device 1150 may incorporate a headphone jack (not shown) for providing another means of providing output signals.

Although described herein in combination with mobile computing device 1150, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 11B is a block diagram illustrating components of a mobile computing device used in one embodiment, such as the mobile computing device 1150 shown in FIG. 11A. That is, mobile computing device 1150 can incorporate a system 1102 to implement some embodiments. For example, system 1102 can be used in implementing a “smartphone” that can run one or more applications similar to those of a desktop or notebook computer. In some embodiments, the system 1102 is integrated as a computing device, such as an integrated personal digital assistant (PDA) and wireless phone.

Application 1167 may be loaded into memory 1162 and run on or in association with an operating system 1164. The system 1102 also includes non-volatile storage 1168 within memory the 1162. Non-volatile storage 1168 may be used to store persistent information that should not be lost if system 1102 is powered down. The application 1167 may use and store information in the non-volatile storage 1168. The application 1167, for example, may comprise functionality for performing routines including, for example, creating visualizations from data in electronic documents, as described above with respect to the operations in routine 900 of FIG. 9. A synchronization application (not shown) also resides on system 1102 and is programmed to interact with a corresponding synchronization application resident on a host computer to keep the information stored in the non-volatile storage 1168 synchronized with corresponding information stored at the host computer. As should be appreciated, other applications may also be loaded into the memory 1162 and run on the mobile computing device 1150.

The system 1102 has a power supply 1170, which may be implemented as one or more batteries. The power supply 1170 might further include an external power source, such as an AC adapter or a powered docking cradle that supplements or recharges the batteries.

The system 1102 may also include a radio 1172 (i.e., radio interface layer) that performs the function of transmitting and receiving radio frequency communications. The radio 1172 facilitates wireless connectivity between the system 1102 and the “outside world,” via a communications carrier or service provider. Transmissions to and from the radio 1172 are conducted under control of OS 1164. In other words, communications received by the radio 1172 may be disseminated to the application 1167 via OS 1164, and vice versa.

The radio 1172 allows the system 1102 to communicate with other computing devices, such as over a network. The radio 1172 is one example of communication media. The embodiment of the system 1102 is shown with two types of notification output devices: the LED 1180 that can be used to provide visual notifications and an audio interface 1174 that can be used with speaker 1130 to provide audio notifications. These devices may be directly coupled to the power supply 1170 so that when activated, they remain on for a duration dictated by the notification mechanism even though processor 1160 and other components might shut down for conserving battery power. The LED 1180 may be programmed to remain on indefinitely until the user takes action to indicate the powered-on status of the device. The audio interface 1174 is used to provide audible signals to and receive audible signals from the user. For example, in addition to being coupled to speaker 1130, the audio interface 1174 may also be coupled to a microphone (not shown) to receive audible (e.g., voice) input, such as to facilitate a telephone conversation. In accordance with embodiments, the microphone may also serve as an audio sensor to facilitate control of notifications. The system 1102 may further include a video interface 1176 that enables an operation of on-board camera 1140 to record still images, video streams, and the like.

A mobile computing device implementing the system 1102 may have additional features or functionality. For example, the device may also include additional data storage devices (removable and/or non-removable) such as, magnetic disks, optical disks, or tape. Such additional storage is illustrated in FIG. 11B by storage 1168.

Data/information generated or captured by the mobile computing device 1150 and stored via the system 1102 may be stored locally on the mobile computing device 1150, as described above, or the data may be stored on any number of storage media that may be accessed by the device via the radio 1172 or via a wired connection between the mobile computing device 1150 and a separate computing device associated with the mobile computing device 1150, for example, a server computer in a distributed computing network such as the Internet. As should be appreciated such data/information may be accessed via the mobile computing device 1150 via the radio 1172 or via a distributed computing network. Similarly, such data/information may be readily transferred between computing devices for storage and use according to well-known data/information transfer and storage means, including electronic mail and collaborative data/information sharing systems.

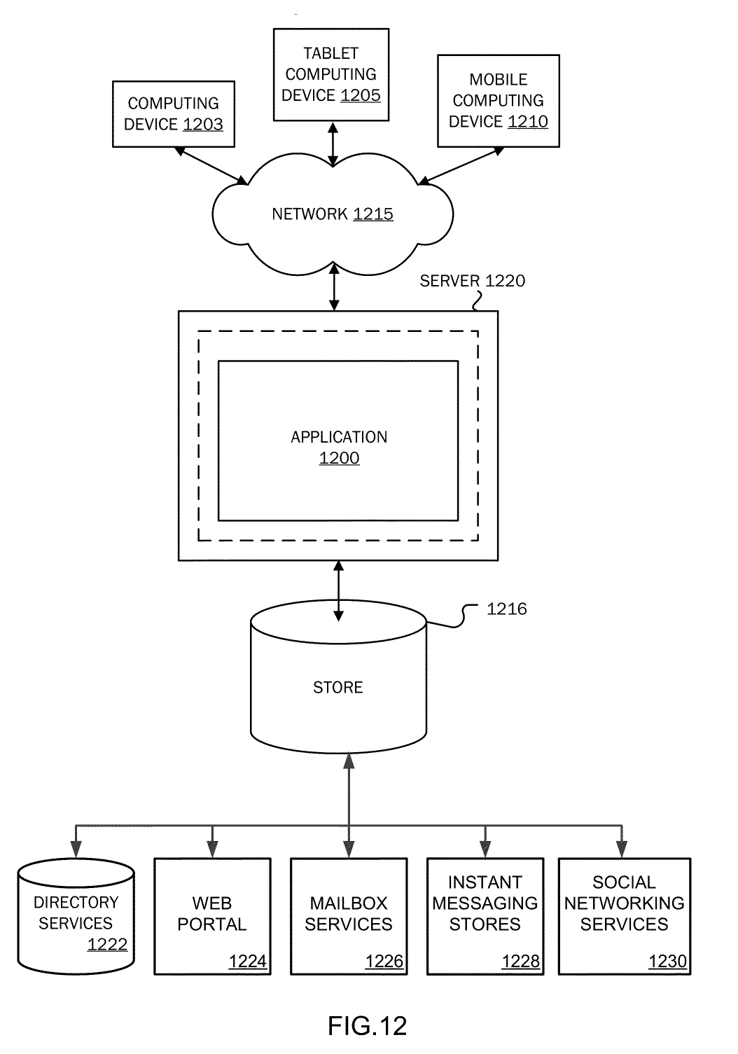

FIG. 12 is a simplified block diagram of a distributed computing system in which various embodiments may be practiced. The distributed computing system may include number of client devices such as a computing device 1203, a tablet computing device 1205 and a mobile computing device 1210. The client devices 1203, 1205 and 1210 may be in communication with a distributed computing network 1215 (e.g., the Internet). A server 1220 is in communication with the client devices 1203, 1205 and 1210 over the network 1215. The server 1220 may store application 1200 which may be perform routines including, for example, creating visualizations from data in electronic documents, as described above with respect to the operations in routine 900 of FIG. 9. Content developed, interacted with, or edited in association with the application 1200 may be stored in different communication channels or other storage types. For example, various documents may be stored using a directory service 1222, a web portal 1224, a mailbox service 1226, an instant messaging store 1228, or a social networking site 1230.

The application 1200 may use any of these types of systems or the like for enabling data utilization, as described herein. The server 1220 may provide the proximity application 1200 to clients. As one example, the server 1220 may be a web server providing the application 1200 over the web. The server 1220 may provide the application 1200 over the web to clients through the network 1215. By way of example, the computing device 10 may be implemented as the computing device 1203 and embodied in a personal computer, the tablet computing device 1205 and/or the mobile computing device 1210 (e.g., a smart phone). Any of these embodiments of the computing devices 1203, 1205 and 1210 may obtain content from the store 1216.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method comprising:
parsing, by a computing device, one or more facts from an electronic document;
searching, by the computing device, for a graphic based on the one or more facts;
generating, by the computing device, a data visualization comprising the one or more facts and the graphic; and
displaying the data visualization.

2. The method of claim 1, wherein parsing, by the computing device, one or more facts from the electronic document comprises utilizing natural language processing to parse the one or more facts from the electronic document.

3. The method of claim 1, wherein parsing, by the computing device, one or more facts from the electronic document comprises parsing a plurality of facts from the electronic document.

4. The method of claim 1, wherein searching, by the computing device, for a graphic based on the one or more facts comprises searching an icon service to retrieve one or more icons corresponding to the one or more facts.

5. The method of claim 2, wherein generating, by the computing device, a data visualization comprising the one or more facts and the graphic comprises generating an infographic comprising the plurality of facts from the electronic document.

6. The method of claim 1, wherein generating, by the computing device, a data visualization based comprising the one or more facts and the graphic comprises determining a graphic option from among a plurality of options for presenting the one or more facts.

7. The method of claim 1, wherein displaying the data visualization in the electronic document comprises displaying the infographic in a gallery.

8. A computing device comprising:
a memory for storing executable program code; and
a processor, functionally coupled to the memory, the processor being responsive to computer-executable instructions contained in the program code and operative to:
parse one or more facts from an electronic document;
search for an icon based on the one or more facts;
generate a data visualization comprising the one or more facts and the icon; and
display the data visualization in the electronic document.

9. The computing device of claim 8, wherein the processor, in parsing the one or more facts from the electronic document, is operative to utilize natural language processing to parse the one or more facts from the electronic document.

10. The computing device of claim 8, wherein the processor, in parsing the one or more facts from the electronic document, is operative to parse a plurality of facts from the electronic document.

11. The computing device of claim 8, wherein the icon corresponds to the one or more facts.

12. The computing device of claim 9, wherein the processor, in generating the data visualization comprising the one or more facts and the icon, is operative to generate an infographic comprising the plurality of facts from the electronic document.

13. The computing device of claim 8, wherein the processor, in generating the data visualization, the one or more facts and the icon, is operative to determine an icon option from among a plurality of options for presenting the one or more facts.

14. The computing device of claim 8, wherein the data visualization is displayed in a gallery in the electronic document.

15. A computer-readable storage medium storing computer executable instructions which, when executed by a computing device, will cause the computing device to perform a method comprising:
parsing a first human readable fact from an electronic document;
parsing a second human readable fact from the electronic document;
searching an icon service for a graphic based on the first human readable fact and the second human readable fact;
generating an infographic comprising the first human readable fact, the second human readable fact and the graphic; and
displaying the infographic in the electronic document.

16. The computer-readable storage medium of claim 15, wherein parsing the first human readable fact from the electronic document comprises utilizing natural language processing to parse the first human readable fact.

17. The computer-readable storage medium of claim 15, wherein parsing the second human readable fact from the electronic document comprises utilizing natural language processing to parse the second human readable fact.

18. The computer-readable storage medium of claim 15, wherein searching an icon service for a graphic based on the first human readable fact and the second human readable fact comprises retrieving one or more icons corresponding to the first human readable fact and the second human readable fact.

19. The computer-readable storage medium of claim 15, wherein generating an infographic comprising the first human readable fact, the second human readable fact and the graphic comprises determining a graphic option from among a plurality of options for presenting the first human readable fact and the second human readable fact.

20. The computer-readable storage medium of claim 15, wherein displaying the infographic in the electronic document comprises displaying the infographic in a gallery.
